(19) United States
(12) Patent Application Publication
(10) Pub. No.: US 2010/0269697 A1
(43) Pub. Date: Oct. 28, 2010

(54) GAS FILTRATION STRUCTURE WITH ASYMMETRICAL HEXAGONAL CHANNELS

(75) Inventors: Adrien Vincent, Cabannes (FR); Fabiano Rodrigues, Roussillon (FR); David Lechevalier, Cambridge, MA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Centre De Recherches et D'Etudes Eur, Courbevoie (FR)

(21) Appl. No.: 12/747,097

(22) PCT Filed: Dec. 18, 2008
(86) PCT No.: PCT/FR08/52360

§ 371 Date: Jun. 9, 2010

(30) Foreign Application Priority Data
Dec. 20, 2007 (FR) 0760111

(51) Int. Cl. B01D 46/00

(52) U.S. Cl. 95/273; 55/522; 55/524

(57) ABSTRACT

The invention relates to a gas filter structure for filtering particulate-laden gases, of the honeycomb type and comprising an assembly of longitudinal adjacent channels of mutually parallel axes separated by porous filtering walls, in which: each outlet channel has a wall common to six inlet walls, each common wall constituting a side of said outlet channel; each outlet channel consists of six sides of approximately identical width a, so as to form a channel of approximately hexagonal and regular cross section; at least two adjacent sides of each inlet channel have a different width; at least two inlet channels sharing a wall with one and the same outlet channel share between them a common wall of width b; and in which the ratio of the widths b/a is greater than 0 but less than 1.

The invention relates to the field of filtering structures that may possibly include a catalytic component, for example those used in an exhaust line of a diesel internal combustion engine.

Filters for the treatment of gases and for eliminating soot particles typically coming from a diesel engine are well known in the prior art. Usually these structures all have a honeycomb structure, one of the faces of the structure allowing entry of the exhaust gases to be treated and the other face allowing exit of the treated exhaust gases. The structure comprises, between the entry and exit faces, an assembly of adjacent ducts or channels, usually square in cross section, having mutually parallel axes separated by porous walls. The ducts are closed off at one or the other of their ends so as to define inlet chambers opening onto the entry face and outlet chambers opening onto the exit face. The channels are alternately closed off in such an order that the exhaust gases, in the course of their passage through the honeycomb body, are forced to pass through the sidewalls of the inlet channels for rejoining the outlet channels. In this way, the particulates or soot particles are deposited and accumulate on the porous walls of the filter body.

Currently, filters made of porous ceramic material, for example cordierite or alumina, especially aluminum titanate, mullite or silicon nitride or a silicon/silicon carbide mixture or silicon carbide, are used for gas filtration.

During its use, it is known that particulate filters are subjected to a succession of filtration (soot accumulation) and regeneration (soot elimination) phases. During the filtration phases, the soot particles emitted by the engine are retained and deposited inside the filter. During the regeneration phases, the soot particles are burnt off inside the filter, so as to restore its filtering properties. The porous structure is therefore subjected to intense radial and tangential thermo-mechanical stresses that may result in micro-cracks liable, over the duration, to result in the unit suffering a severe loss of filtration capacity, or even its complete deactivation. This phenomenon is observed in particular in large-diameter monolithic filters.

To solve these problems and increase the lifetime of the filters, it was proposed more recently to provide filter structures made up from combining several honeycomb blocks or monoliths. The monoliths are usually bonded together by means of an adhesive or cement of ceramic nature, hereafter in the description called joint cement. Examples of such filtering structures are for example described in the patent applications EP 816 065, EP 1 142 619, EP 1 455 923, WO 2004/090294 or WO 2005/063462. To ensure optimum relaxation of the stresses in such an assembled structure, it is known that the thermal expansion coefficients of the various parts of the structure (filter monoliths, coating cement, joint cement) must be substantially of the same order of magnitude. Consequently, said parts are advantageously synthesized on the basis of the same material, usually silicon carbide SiC or cordierite. This choice also ensures uniform heat distribution during regeneration of the filter.

To obtain the best performance in terms of thermo-mechanical strength and pressure drop, the assembled filters currently available for light vehicles typically comprise about 10 to 20 monoliths having a square or rectangular cross section, the elementary cross-sectional area of which is between about 13 cm² and about 25 cm². These monoliths consist of a plurality of channels usually of square cross section. To further reduce the mass of the filter without reducing its performance in terms of pressure drop and soot storage, one obvious solution would be to reduce the number of monoliths in the assembly by increasing their individual size. Such an increase is, however, not currently possible, in particular with SiC filters, without unacceptably reducing the thermo-mechanical strength of the filter.

The filters of larger cross section, currently used in particular for “truck” applications, are produced by assembling, by means of a jointing cement, monoliths having a size similar to those constituting the filters intended for light vehicles. The number of monoliths of truck filter type is then very high and may comprise up to 30 or even 80 monoliths. Such filters then have an excessively high overall weight and too high a pressure drop.

In general, there is therefore at the present time a need to increase both the overall filtration performance and the lifetime of current filters.

More precisely, the improvement of filters may be directly measured by comparing the properties that follow, the best possible compromise between these properties being sought according to the invention for equivalent engine speeds. In particular, the subject of the present invention is a filter or a filter monolith having, all at the same time:

a low pressure drop caused by the filtering structure in operation, i.e. typically when it is in an exhaust line of an internal combustion engine, both when such structure is free of soot particles (initial pressure drop) and when it is laden with particles;

an increase in the pressure drop across the filter during said operation which is as small as possible, i.e. a small increase in the pressure drop measured as a function of the operating time or more precisely as a function of the level of soot loading of the filter;

a high total surface area for filtration;

a monolith mass suitable for ensuring a sufficient thermal mass for minimizing the maximum regeneration temperature and the thermal gradients undergone by the filter, which may themselves induce cracks in the monolith;

a high soot storage volume, especially at constant pressure drop, so as to reduce the frequency of regeneration;

a high thermo-mechanical strength, i.e. allowing a prolonged lifetime of the filter; and

a higher residue storage volume.

The increase in the pressure drop as a function of the level of soot loading of the filter is in particular able to be measured directly by the loading slope Δ_{P}/Mₛₒₒₜ, in which ΔP represents the pressure drop and Mₛₒₒₜ represents the mass of soot accumulated in the filter.

To improve one or the other of the properties described above, it has already been proposed in the prior art to modify the shape of the channels of the filtering structure in various ways.

For example, to increase the filtration surface area of said filter to a constant filter volume, patent application WO 05/016491 proposed filter monoliths in which the inlet and outlet channels are of different shape and different internal volume. In such structures, the wall elements follow one another in cross section and along a horizontal and/or vertical row of channels so as to define a sinusoidal or wavy shape. The wall elements form a wave typically with a sinusoidal half-period over the width of a channel. Such channel configurations make it possible to obtain a low pressure drop and a high soot storage volume. However, this type of structure has an excessively high initial pressure drop combined with an excessively high soot loading slope and the filters produced with this type of channel configuration therefore do not meet all the requirements defined above.

According to another configuration, patent U.S. Pat. No. 4,417,908 proposes cells or channels of hexagonal section, an inlet channel being surrounded by six outlet channels (see in particular FIG. 11). However, the soot storage volume of such structures still remains overall low.

Alternatively, patent application EP 1 538 133 teaches configurations of asymmetric hexagonal cells, enabling the soot and residue storage volume to be increased over structures with channels having a square cross section, or a constant channel density and constant wall thickness. However, the configuration described in FIG. 14 leads to an excessively low residue storage volume and a high loading slope, the filtration area remaining low. Furthermore, this configuration of the channels results in an excessively high filter weight. When the filter is in operation, experiments conducted by the applicant have demonstrated that having a greater quantity of residue that can potentially be stored by said filter when this filter is fitted in an exhaust line of an internal combustion engine ultimately results in an appreciably extended filter life.

Thus it may be seen that, although each of the configurations of the prior art does improve at least one of the desired properties, none of the solutions described provides an acceptable compromise between the set of desired properties, as explained above. In general, it may be pointed out that, for each of the configurations of the prior art, an improvement obtained for one of the properties of the filter is accompanied at the same time by a deterioration in another, so that the improvement finally obtained is generally minor as regards the induced drawbacks.

Thus, the object of the present invention is to provide a filtering structure having the best compromise between induced pressure drop, loading slope ΔP/Mₛₒₒₜ, mass, total filtration surface area, soot and residue storage volume and thermo-mechanical strength, as described above.

In its most general form, the present invention relates to a gas filter structure for filtering particulate-laden gases, of the honeycomb type and comprising an assembly of longitudinal adjacent channels of mutually parallel axes separated by porous filtering walls, said channels being alternately blocked off at one or the other of the ends of the structure so as to define inlet channels and outlet channels for the gas to be filtered and so as to force said gas to pass through the porous walls separating the inlet and outlet channels, said structure being characterized in that:

each outlet channel has a wall common to six inlet walls, each common wall constituting one side of said outlet channel;

each outlet channel consists of six sides of approximately identical width a, so as to form a channel of approximately hexagonal and regular cross section;

at least two adjacent sides of each inlet channel have a different width,

at least two inlet channels sharing a wall with one and the same outlet channel share between them a common wall of width b; and

the ratio of the widths b/a is greater than 0 but less than 1.

Preferably, the ratio of the widths b/a is between 0.1 and 0.95, preferably between 0.2 and 0.9 and highly preferably, between 0.3 and 0.85.

According to one possible embodiment, the walls constituting the inlet and outlet channels are plane.

According to an alternative embodiment, the walls constituting the inlet and outlet channels are wavy, that is to say that, in cross section, and with respect to the center of a channel, they have at least one concave portion or at least one convex portion.

The outlet channels may have walls that are convex with respect to the center of said channels. Without departing from the scope of the invention, the outlet channels may equally have walls that are concave with respect to the center of said channels.

For preference, the common wall of width b between two inlets channels is plane.

According to this alternative embodiment, the maximum distance, along a cross section, between an extreme point of the concave and/or convex wall or walls and the straight segment connecting the two ends of said wall is greater than 0 and less than 0.5a.

The filter structures according to the invention have a density of the channels between about 1 and about 280 channels per cm² and preferably between 15 and 40 channels per cm².

The average wall thickness is between 100 and 1000 microns, and preferably between 150 and 450 microns.

In the filter structures according to the invention, the width a of the outlet channels is typically between about 0.10 mm and about 4.00 mm, and preferably between about 0.20 mm and about 2.50 mm.

In the filter structures according to the invention, the width b of the wall common to two inlet channels is typically between about 0.05 mm and about 4.00 mm and preferably between about 0.20 mm and about 1.00 mm.

According to one embodiment, the walls are based on silicon carbide SiC.

The invention relates in particular to an assembled filter comprising a plurality of filtering structures as described above, said structures being bonded together by a cement.

The invention further relates to the use of a filter structure or of an assembled filter as described above as a pollution control device on an exhaust line of a diesel or gasoline engine, preferably a diesel engine.

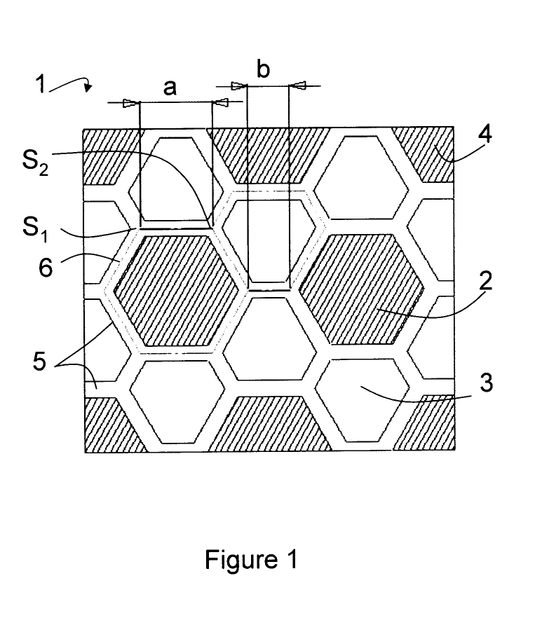

FIGS. 1, 2 and 3 illustrate two nonlimiting embodiments of a filtering structure having a channel configuration according to the invention.

FIG. 1 is a front elevation view of a portion of the front face of a filter according to a first embodiment according to the invention, comprising inlet and outlet channels having six walls and in which said walls are plane.

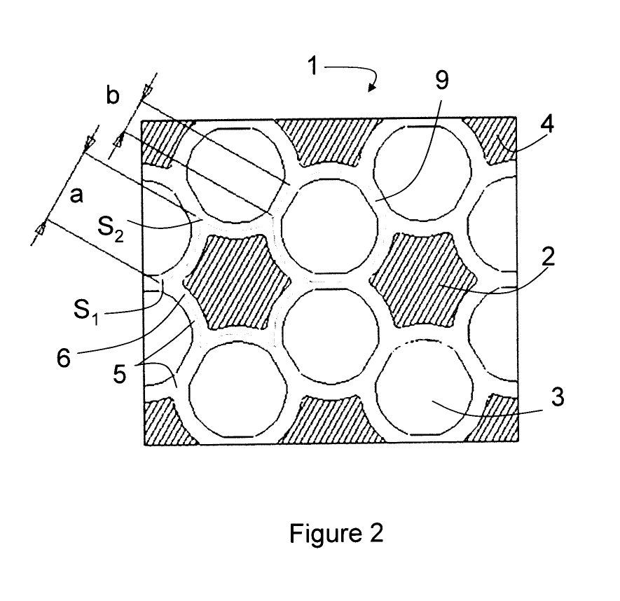

FIG. 2 is a front elevation view of a portion of the front face of a filter according to a second embodiment according to the invention, comprising inlet and outlet channels having six walls and in which said walls are wavy. According to this embodiment, an outlet channel consists of walls that are convex with respect to its center of said channel.

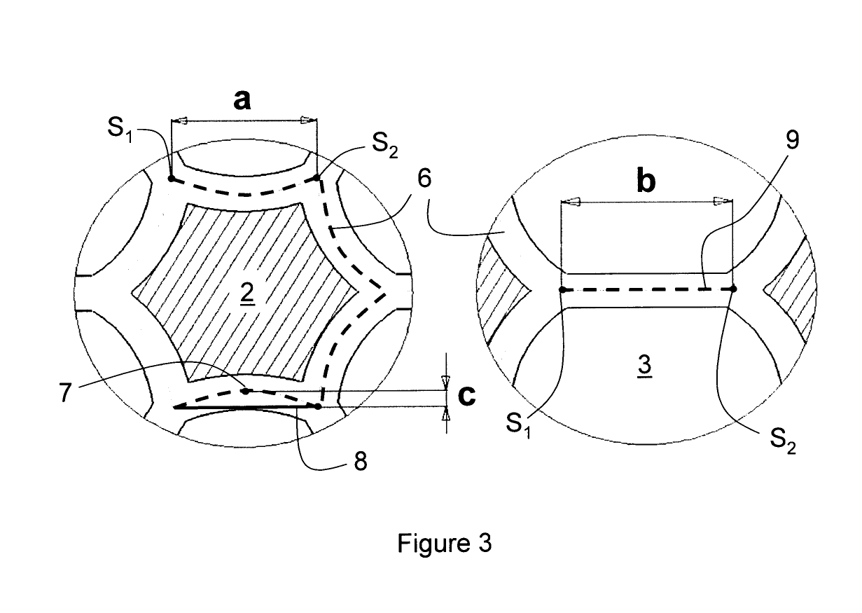

FIG. 3 illustrates in greater detail the embodiment already described in relation to FIG. 2.

FIG. 1 shows an elevation view of the gas entry face of a portion of the monolith filtration unit 1. The unit has inlet channels 3 and outlet channels 2. The outlet channels are conventionally closed off on the gas entry face by plugs 4. The inlet channels are also blocked, but on the opposite (rear) face of the filter, so that the gases to be purified are forced to pass through the porous walls 5. The filtering structure according to the invention is characterized by the presence of an outlet channel 2, the cross section of which has a regular hexagonal shape, that is to say the six sides of the hexagon are of substantially identical length a and two adjacent sides make an angle close to 120°. A regular outlet channel 2 is in contact with six inlet channels 3 of also hexagonal but irregular general shape, i.e. formed by adjacent walls, at least two of which have a different width in cross section.

According to the invention, the inlet channels have a common wall of length b.

The structures according to the invention are characterized in that the ratio b/a is greater than 0 but strictly less than 1.

As shown in the appended cross-sectional views (FIGS. 1 to 3), the distances a and b are defined according to the invention as the distances connecting the two vertices S1 and S2 of the wall in question, said vertices S1 and S2 lying on the central core 6 of said wall (see FIG. 1 et seq.). Thus, values of a and b independent of the thickness of the walls are obtained. Preferably, the thickness of the walls is constant according to the invention over the entire length of the thickness of the filter.

FIG. 2 shows the layout of a set of gas outlet 2 and inlet 3 channels in an elevation of the face via which the gases to be purified enter a honeycomb structure according to the invention, and the walls of which are wavy. The outlet channels consist of walls that are convex with respect to their centers. Within this structure and as shown in FIG. 3, the maximum distance c, in cross section, is defined as the distance between the extreme point 7 of a wavy wall and the straight segment 8 connecting the two ends S1 and S2 of the wall.

For the embodiments according to the invention in which the walls are wavy, concave or convex, the distance c is greater than 0 and less than 0.5 a (0.5×a). For preference, this ratio is greater than 0.01 a and highly preferably, greater than 0.03 a, or even greater than 0.05 a. For preference, this ratio is less than 0.30 a and highly preferably, less than 0.20 a.

According to one possible embodiment, two (plane or wavy) walls of an inlet channel at 60° are of equal width in a structure according to the invention. According to one possible embodiment, two adjacent walls of an inlet channel of a structure according to the invention are of different widths.

The invention and its advantages over the already known structures will be more clearly understood on reading the following nonlimiting examples.

### EXAMPLE 1

A first population of honeycomb-shaped monoliths made of silicon carbide was synthesized according to the prior art, for example in monoliths described in the patents EP 816 065, EP 1 142 619, EP 1 455 923 or WO 2004/090294.

To do this, the following were mixed in a mixer:

3000 g of a blend of silicon carbide grains or particles having a purity of greater than 98% and consisting of two particle size fractions. A first fraction had a median diameter d₅₀ of between 5 μm and 50 μm, at least 10% by weight of the particles making up this fraction having a diameter greater than 5 μm. The second fraction had a median particle diameter of less than 5 μm. Within the context of the present invention, the term “median diameter” is understood to mean the diameter of the particles below which 50% by weight of the population of particles lie; and

150 g of an organic binder of the cellulose type.

Water was then added and mixed until a uniform paste having a plasticity suitable for extrusion was obtained, the extrusion die being configured so as to obtain monolith blocks of a square cross section, the internal channels of said blocks also having a cross section of square shape, such as those currently sold.

The green monoliths obtained were microwave-dried for a time long enough to bring the water content of chemically non-bound water to less than 1% by weight.

The channels of each face of the monolith were alternately blocked using well-known techniques, for example those described in the application WO 2004/065088.

The monoliths (elements) were then fired at a temperature above 2100° C., said temperature being maintained for 5 hours. The porous material obtained had an open porosity of 39% and an average pore distribution diameter of around 15 μm. The dimensional characteristics of the monoliths thus obtained are given in table 1 below, the structure having a periodicity, i.e. a distance between two adjacent channels, of 1.89 mm.

An assembled filter was then formed from the monoliths. Sixteen elements obtained from the same mixture were assembled together using conventional techniques by bonding, using a cement of the following chemical composition: 72 wt % SiC, 15 wt % Al₂O₃, 11 wt % SiO₂, the remainder consisting of impurities, predominantly Fe₂O₃ and alkali and alkaline-earth metal oxides. The average thickness of the joint between two neighboring blocks was around 1 to 2 mm. The whole assembly was then machined so as to constitute assembled filters of cylindrical shape with a diameter of about 14.4 cm.

### EXAMPLE 2

The monolith synthesis technique described above was also repeated in the same way, but this time the extrusion die was designed so as to produce monolith blocks characterized by a wavy arrangement of the internal channels. Monoliths in accordance with those described in relation to FIG. 3 of patent application WO 05/016491 were obtained. In cross section, the waviness of the walls was characterized by a degree of asymmetry, as defined in patent application WO 05/016491, equal to 11%. The dimensional characteristics of the elements thus obtained are given in table 1 below, the structure having a periodicity, i.e. a distance between two adjacent channels, of 1.95 mm.

### EXAMPLE 3

The monolith synthesis technique described above was also repeated in the same way, but this time the extrusion die was designed to produce monolith blocks characterized by an octagonal arrangement of the internal inlet channels (often called a square/octagonal structure in the field) as illustrated by FIG. 6b of patent application EP 1 495 791. The dimensional characteristics of the elements thus obtained are given in table 1 below, the structure having a periodicity, i.e. a distance between two adjacent channels, of 2.02 mm.

### EXAMPLE 4

The synthesis technique described above was also repeated in the same way, but this time the extrusion die was designed so as to produce monolith blocks characterized by an arrangement of the internal inlet and outlet channels having a cross section of regular hexagonal shape, said channels being formed by plane walls, in accordance with the teaching of FIG. 11 of Corning patent U.S. Pat. No. 4,417,908. The parameters of the structure having regular hexagonal channels thus obtained were a=b=1.45 mm.

### EXAMPLE 5

The monolith synthesis technique described above was also repeated in the same way, but this time the extrusion die was designed so as to produce monolith blocks characterized by a hexagonal arrangement of the internal inlet channels, as illustrated by FIG. 14 of patent application EP 1 538 133 with the following a and b parameters:

a=1.45 mm;
b=0.76 mm;
b/a=0.52.

### EXAMPLE 6

### According to the Invention

The monolith synthesis technique described above was also repeated in the same way, but this time the extrusion die was designed so as to produce monolith blocks characterized by an arrangement of the internal channels according to FIG. 1 as previously described, with plane walls. The arrangement of the channels was characterized by the following values:
a=1.45 mm;
b=0.76 mm;
b/a=0.52.

### EXAMPLE 7

### According to the Invention

The monolith synthesis technique described above was also repeated in the same way, but this time the extrusion die was designed to produce monolith blocks characterized by an arrangement of the internal channels according to the invention and in accordance with the representation given in FIG. 2, i.e. with wavy walls. The arrangement of the channels is characterized by the following values:
a=1.45 mm;
b=0.76 mm;
b/a=0.52
c=0.20 mm, i.e. 0.14a.

The main structural characteristics of the monoliths obtained according to examples 1 to 7 are given in table 1 below. The filter assembly/production technique was the same for all the examples and as described in example 1.

TABLE 1

| | Examples | | | | | | |
|---|---|---|---|---|---|---|---|
| | 1 | 2 | 3 | 4 | 5 | 6 | 7 |
| Channel | Square | Wavy | Square/ | Regular | Asymmetric | Acc. | Acc. |
| geometry | | | Octagonal | hexagonal | hexagonal | invention | invention |
| | | | | | EP1538133 | (plane | (wavy |
| | | | | | | walls) | walls) |
| Size of the | 36 | 36 | 36 | 36 | 36 | 36 | 36 |
| monolith | | | | | | | |
| elements (mm) | | | | | | | |
| Parameter a | — | — | — | 1.45 | 1.45 | 1.45 | 1.45 |
| (mm) | | | | | | | |
| Length of the | 20.32 | 20.32 | 20.32 | 20.32 | 20.32 | 20.32 | 20.32 |
| elements (cm) | | | | | | | |
| Thickness e of | 380 | 340 | 390 | 300 | 300 | 300 | 300 |
| the internal | | | | | | | |
| walls (μm) | | | | | | | |
| Inlet | 1/1 | 1/1 | 1/1 | 2/1 | 2/1 | 2/1 | 2/1 |
| channel/outlet | | | | | | | |
| channel ratio | | | | | | | |

The specimens obtained were evaluated and characterized according to the following operating methods:

A—Pressure Drop Measurement in the Soot-Laden and Soot-Free State and Loading Slope Measurement:

The term “pressure drop” is understood within the present invention to mean the pressure difference that exists between the upstream and the downstream end of the filter. The pressure drop was measured using the standard techniques for a gas flow rate of 250 kg/h and a temperature of 250° C. firstly on fresh filters.

For the laden filter loss measurement, the various filters were mounted beforehand on an exhaust line of a 2.0-liter diesel engine operating at full power (4000 rpm) for 30 minutes, after which they were removed and weighed so as to determine their initial mass. The filters were then put back on the engine test bed and run at a speed of 3000 rpm and a torque of 50 Nm so as to obtain soot loads in the filter of 7 g/l. The pressure drop across the filter thus laden with soot was measured as on the fresh filter. The pressure drop as a function of various loading levels between 0 and 10 grams/liter was also measured so as to establish the loading slope ΔP/Mₛₒₒₜ.

B—Thermo-Mechanical Strength Measurement:

The filters were mounted on an exhaust line of a 2.0-liter direct-injection diesel engine operating at full power (4000 rpm) for 30 minutes, after which they were removed and weighed so as to determine their initial mass. The filters were then put back on the engine test bed and run at a speed of 3000 rpm and a torque of 50 Nm for different times so as to obtain a soot load of 8 g/liter (by volume of the filter). The filters thus laden were put back on the line so as to undergo a severe regeneration thus defined: after stabilization at an engine speed of 1700 rpm for a torque of 95 Nm for 2 minutes, a post-injection is carried out with 70° of phase shift for a post-injection volume of 18 mm³/cycle. Once the soot combustion has been started, more precisely when the pressure drop decreases over at least 4 seconds, the engine speed is lowered to 1050 rpm for a torque of 40 Nm for five minutes so as to accelerate the soot combustion. The filter is then exposed to an engine speed of 4000 rpm for 30 minutes so as to remove the remaining soot.

The regenerated filters were inspected after being cut up, so as to reveal the possible presence of cracks visible to the naked eye. The thermo-mechanical strength of the filter was assessed according to the number of cracks, a low number of cracks representing an acceptable thermo-mechanical strength for use as a particulate filter.

As indicated in table 2, the following ratings were assigned to each of the filters:

+++: presence of very many cracks;

++: presence of many cracks;

+: presence of a few cracks;

−: no cracks or rare cracks.

The residue storage volume and the filtration surface area were determined, for each filter, according to the usual techniques well known in the field.

The results obtained in the tests for all examples 1 to 7 are given in table 2 below:

TABLE 2

| | Examples | | | | | | |
|---|---|---|---|---|---|---|---|
| | 1 | 2 | 3 | 4 | 5 | 6 | 7 |
| Channel geometry | Square | Wavy | Square/ | Regular | Asymmetric | Acc. | Acc. |
| | | | Octagonal | hexagonal | hexagonal | invention | invention |
| | | | | | EP1538133 | (plane | (wavy |
| | | | | | | walls) | walls) |
| Filtration surface | 844 | 913 | 911 | 896 | 603 | 968 | 1060 |
| area (m²/m³) | | | | | | | |
| Filter mass | 2627 | 2394 | 2448 | 1967 | 2237 | 2102 | 2156 |
| (grams) | | | | | | | |
| Residue storage | 648 | 977 | 967 | 1026 | 678 | 758 | 1029 |
| volume (cm³) | | | | | | | |
| Pressure drop ΔP₀ | 29 | 34.5 | 39 | 30 | 28 | 22 | 33 |
| (mbar) in the | | | | | | | |
| fresh state (not | | | | | | | |
| laden with soot) | | | | | | | |
| Pressure drop ΔP₀ | 165 | 110 | 118 | 119 | 157 | 95 | 104 |
| (mbar) in the | | | | | | | |
| soot-laden state | | | | | | | |
| (7 g/l) | | | | | | | |
| Loading slope | 19.4 | 10.8 | 11.3 | 12.7 | 18.4 | 10.4 | 10.1 |
| [Pa/gₛₒₒₜ/l_{filter}] | | | | | | | |
| Presence of cracks | +++ | ++ | ++ | + | + | − | − |
| after 8 g/l soot | | | | | | | |
| loading and severe | | | | | | | |
| regeneration | | | | | | | |

### Analysis of the Results:

The results given in table 2 show that the filters according to examples 6 and 7 have the best compromise between the various desired properties in an application as a particulate filter in an automobile exhaust line.

The filters according to examples 6 and 7 also have better thermo-mechanical strength than the filters according to the prior art.

More particularly, because of this better compromise, it becomes possible according to the invention to synthesize assembled structures from monoliths of larger size than hitherto, while still ensuring that it has a longer lifetime.

1. A gas filter structure for filtering at least one particulate-laden gas, of a honeycomb pattern and comprising an assembly of longitudinal adjacent channels of mutually parallel axes separated by porous filtering walls, said channels being alternately blocked off at one or the other end of the structure so as to define inlet channels and outlet channels for the at least one particulate-laden gas to be filtered and so as to force said gas to pass through the porous walls separating the inlet and outlet channels, whereby in said gas filter structure:
i. each outlet channel comprises a common wall common to six inlet walls, each common wall being one side of said outlet channel;
ii. each outlet channel comprises six sides of approximately identical width a, so as to form a channel of approximately hexagonal and regular cross section;
iii. at least two adjacent sides of each inlet channel have a different width;
iv. at least two inlet channels sharing a wall with one same outlet channel share between them a narrow common wall of width b; and
v. the ratio of widths b/a is greater than 0 but less than 1.

2. The gas filter structure according to claim 1, wherein the ratio of widths b/a is between 0.1 and 0.95.

3. The gas filter structure according to claim 1, wherein the walls constituting the inlet or outlet channels are planar.

4. The gas filter structure according to claim 1, wherein the walls of the inlet and outlet channels are wavy, in cross section and with respect to the center of a channel, comprising at least one concave portion or at least one convex portion.

5. The gas filter structure according to claim 4, wherein the outlet channels comprise walls that are convex with respect to the center of said outlet channels.

6. The gas filter structure according to claim 4, wherein the outlet channels comprise walls which are concave with respect to the center of said outlet channels.

7. The gas filter structure according to claim 4, wherein the narrow common wall of width b between two inlet channels is planar.

8. The gas filter structure according to claim 4, wherein a the maximum distance, along a cross section, between an extreme point of the wall or walls comprising at least one concave or convex portion and the straight segment connecting two ends of said wall is greater than 0 and less than 0.5a.

9. The gas filter structure according to claim 1, wherein the density of the channels is between about 1 and about 280 channels per cm².

10. The gas filter structure according to claim 1, wherein average wall thickness is between 100 and 1000 microns.

11. The gas filter structure according to claim 1, wherein the width a of the outlet channels is between about 0.1 mm and about 4.00 mm.

12. The gas filter structure according to claim 1, wherein the width b of the wall common to two inlet channels is between about 0.05 mm and about 4.00 mm.

13. The gas filter structure according to claim 1, wherein the walls comprise silicon carbide SiC.

14. An assembled filter comprising a plurality of filtering structures according to claim 1, wherein said structures are bonded together by a cement.

15. A method of controlling pollution, comprising adding a filter structure or an assembled filter according to claim 1 to an exhaust line of a diesel or gasoline engine.

16. The gas filter structure according to claim 1, wherein the ratio of widths b/a is between 0.2 and 0.9.

17. The gas filter structure according to claim 1, wherein the ratio of widths b/a is between 0.3 and 0.85.

18. The gas filter structure according to claim 1, wherein the density of the channels is between 15 and 40 channels per cm².

19. The gas filter structure according to claim 1, wherein average wall thickness is between 150 and 450 microns.

20. The gas filter structure according to claim 1, wherein the width a of the outlet channels is between about 0.20 mm and about 2.50 mm.
